(19) United States
(12) Patent Application Publication
(10) Pub. No.: US 2026/0307962 A1
(43) Pub. Date: Oct. 8, 2026

(54) LIFTING DEVICE FOR AUTONOMOUS MOBILE ROBOT

(71) Applicant: Hwa young Jung, Changwon-si (KR)

(72) Inventor: Hwa young Jung, Changwon-si (KR)

(21) Appl. No.: 19/195,601

(22) Filed: Apr. 30, 2025

(30) Foreign Application Priority Data
Sep. 25, 2024 (KR) 10-2024-0129496

(51) Int. Cl. B66F 9/06; B66F 9/065; B66F 9/12

(52) U.S. Cl. CPC B66F 9/063; B66F 9/065; B66F 9/12

(57) ABSTRACT

The present disclosure relates to a lifting device for an autonomous mobile robot that is used to lift and lower a cart in which given items are received or the items themselves, more specifically to a lifting device for an autonomous mobile robot that is capable of being used to lift a cart in which items are received to a given height to allow the autonomous mobile robot to deliver the items to a given place, thereby preventing wheels (casters) mounted on the cart from being worn out and transferring the items, without any additional labor.

### CROSS REFERENCE TO RELATED APPLICATION OF THE DISCLOSURE

The present application claims the benefit of Korean Patent Application No. 10-2024-0129496 filed in the Korean Intellectual Property Office on Sep. 25, 2024, the entire contents of which are incorporated herein by reference.

### BACKGROUND OF THE DISCLOSURE

### Field of the Disclosure

The present disclosure relates to a lifting device for an autonomous mobile robot that is used to lift and lower a cart in which given items are received or the items themselves, more specifically to a lifting device for an autonomous mobile robot that is capable of being used to lift a cart in which items are received to a given height to allow the autonomous mobile robot to deliver the items to a given place, thereby preventing wheels (casters) mounted on the cart from being worn out and transferring the items, without any additional labor.

### Background of the Related Art

Automated guided vehicles (AGVs) for moving items are vehicles that are autonomous and driverless and repeatedly move the items in an efficient way, so that they are used in various industrial sites.

Further, autonomous mobile robots (AMRs) have been suggested to solve disadvantages the AGVs have. The AMRs are faster in moving speed than the AGVs, guided in real time on moving paths using different sensors mounted thereon, and adjustable on the moving paths in real time. Therefore, the AMRs are gradually widened in their utilization range.

The AGVs or AMRs serve to move to a given place, while loading items on tops thereof, and if they move with a cart mounted thereon, it is desirable that they should move in a state where the cart is placed on top thereof to prevent the cart's casters from being worn out. In this case, a lifting device for lifting and lowering the cart is needed.

A conventional technology relating to automatic item transport is disclosed in Korean Patent No. 10-2151764 entitled ‘Item transport robot and transport system having the same’.

The conventional item transport robot includes: a storage space portion in which items are received; doors located on one side of the storage space portion; a robot conveyor located inside the storage space portion and having a rotating part on which the items are placed and a driving part for rotating the rotating part; a gear located on the front side of the robot conveyor in such a way as to engage with an external conveyor; and a rotational force-transmitting part located between a rotary shaft of the rotating part and the gear to transmit a rotational force, and in this case, the transport robot makes use of all power such as the driving power of the conveyor for loading the items thereon, transporting the items, and unloading the items therefrom to the outside, so that the amount of a battery consumed increases to reduce the use time of the transport robot.

A conventional technology relating to an autonomous mobile robot for cart transport is disclosed in Korean Patent No. 10-2550889 as filed by the same applicant as the present disclosure, which is entitled ‘Item transport system using autonomous mobile robot’.

The conventional item transport system that makes use of an AMR to transport items in a given place includes: the AMR 1 moving along predetermined paths or along moving paths obtained with acquired information; a cart 20 loaded on the AMR 1 to move and having items W to be transported loaded therein; and a conveyor part 40 receiving the items W loaded into the cart 20 and moving the items W to a given position, wherein the conveyor part 40 includes a base frame 41 on which a conveyor 43 for transporting the items W is located, leg frames 42 fixedly disposed on the base frame 41, a male docking part 50 fixedly disposed on the base frame 41 to perform docking with the cart 20, and an RFID reader 58 located on one side thereof to recognize the cart 20 if the cart 20 is close thereto. In this case, a lifting part for lifting and lowering the cart is built, but the lifting part makes use of a generally used power base to lift and lower the cart, so that it is not easy to adjust the lifting and lowering height of the cart, and the lifting part is relatively bulky in volume to cause an amount of the power consumed for the AMR to increase, thereby reducing the use time of the AMR and increasing the power consumption cost thereof.

A conventional technology relating to a lifting device for an autonomous mobile robot is disclosed in Korean Patent No. 10-2659793 as filed by the same applicant as the present disclosure, which is entitled ‘Item lifting device for autonomous mobile robot’.

The conventional item lifting device 10 is mounted on an autonomous mobile robot 1 to lift items up and includes a base plate 11 fixedly disposed onto a top of the autonomous mobile robot 1, an actuator 12 fixedly disposed onto the base plate 11 in such a way as to operate with the power applied thereto, a driving bar 14 fixedly coupled to an actuator rod 13 that reciprocates by means of the actuator 12 and thus moves together with the actuator rod 13, driving brackets 15 fixedly coupled to the driving bar 14 and having driving rollers 16 rotatably fixedly coupled to one side thereof, slant brackets 17 fixedly coupled to one side of the driving brackets 15 and each having a slant surface with a given angle, lifting and lowering plates 18 disposed on one side of the slant brackets 17 in such a way as to be lifted and lowered by means of the movements of the slant brackets 17, and a lifting plate 20 fixedly coupled to the lifting and lowering plates 18. In this case, the lifting and lowering plates 18 are located on both sides of the base plate 11, and a plurality of reinforcing bars 22 are located between the lifting and lowering plates 18, thereby enhancing the durability of the lifting plate 20 fixedly coupled to the reinforcing bars 22 and achieving constant lifting and lowering operations of the lifting plate 20. In this case, advantageously, the durability of the lifting plate 20 is improved, but disadvantageously, the lifting and lowering operations of the lifting plate 20 are not performed smoothly.

### SUMMARY OF THE DISCLOSURE

Accordingly, the present disclosure has been made in view of the above-mentioned problems occurring in the related art, and it is an object of the present disclosure to provide a lifting device for an autonomous mobile robot that is capable of being used to lift a cart in which items are received to a given height to allow the autonomous mobile robot to deliver the items to a given place, thereby preventing wheels (casters) mounted on the cart from being worn out and transferring the items, without any additional labor.

It is another object of the present disclosure to provide a lifting device for an autonomous mobile robot that is capable of being configured to have two limit switches mounted on a base plate, a driving bar located between the two limit switches in such a way as to move by means of an actuator, and a touch bracket fixedly located on the underside of a driving bar, so that the limit switches serve to sense the position of the driving bar and limit the movable range of the driving bar, thereby preventing malfunctions from occurring.

It is yet another object of the present disclosure to provide a lifting device for an autonomous mobile robot that is capable of being configured to have linear motion (LM) rails located on a base plate and LM blocks fixedly disposed on slant brackets, so that the slant brackets are guided on paths by means of the LM blocks and the LM rails and move smoothly.

It is still another object of the present disclosure to provide a lifting device for an autonomous mobile robot that is capable of being configured to have fixing pins fixedly coupled to a lifting plate in such a way as to coupledly pass through lifting and lowering plates, so that as one side of each fixing pin is located under a guide bracket corresponding thereto, the lifting plate, reinforcing bars, the lifting and lowering plates, and reinforcing bar-fixing brackets are prevented from being separated from the outsides of guide blocks, thereby reducing the occurrence of safety accidents, and if necessary, the fixing pins are separated from the lifting plate, the lifting plate, the reinforcing bars, the reinforcing bar-fixing brackets, and the lifting and lowering plates are separated from the guide blocks at a time, thereby performing the maintenance for the components conveniently.

It is yet still another object of the present disclosure to provide a lifting device for an autonomous mobile robot that is capable of being configured to have guide blocks mounted on a base plate and lifting and lowering guide rollers located on one side of lifting and lowering plates, so that while the lifting and lowering plates are being lifted and lowered, the lifting and lowering guide rollers move, while being guided on moving paths by means of the guide blocks, and are smoothly lifted and lowered.

To accomplish the above-mentioned objects, according to the present disclosure, there is provided a lifting device for an autonomous mobile robot to lift up items, including: a base plate fixedly disposed onto a top of the autonomous mobile robot; an actuator fixedly disposed onto the base plate in such a way as to operate with the power applied thereto; a driving bar fixedly coupled to an actuator rod that reciprocates by means of the actuator and thus moves together with the actuator rod; slant brackets fixedly coupled to the driving bar and each having a slant surface with a given angle; lifting and lowering plates disposed on one side of the slant brackets in such a way as to be lifted and lowered by means of the movements of the slant brackets; and a lifting plate fixedly coupled to the lifting and lowering plates, wherein the lifting and lowering plates are located on both sides of the base plate and have driven rollers located on one side thereof, so that if the actuator rod moves to a direction of escaping from the actuator, the driven rollers move up along the slant surfaces of the slant brackets to allow the lifting and lowering plates to be lifted, and then, as the lifting and lowering plates are lifted, the lifting plate is lifted.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a schematic view showing an autonomous mobile robot in which a lifting device according to the present disclosure is built;

FIG. 2 is a perspective view showing the lifting device according to the present disclosure;

FIG. 3 is an exploded perspective view showing the lifting device according to the present disclosure;

FIG. 4 is a perspective view showing a portion of the lifting device according to the present disclosure;

FIG. 5 is a plan view showing the lifting device according to the present disclosure; and

FIG. 6 is an exemplary view showing an operation of the lifting device according to the present disclosure.

### DETAILED DESCRIPTION OF THE PREFERRED EMBODIMENT

The present disclosure relates to a lifting device for an autonomous mobile robot that is used to lift and lower a cart in which given items are received or the items themselves, more specifically to a lifting device for an autonomous mobile robot that is capable of being used to lift a cart in which items are received to a given height to allow the autonomous mobile robot to deliver the items to a given place, thereby preventing wheels (casters) mounted on the cart from being worn out and transferring the items, without any additional labor.

Hereinafter, an embodiment of the present disclosure will be explained in detail with reference to the attached drawings.

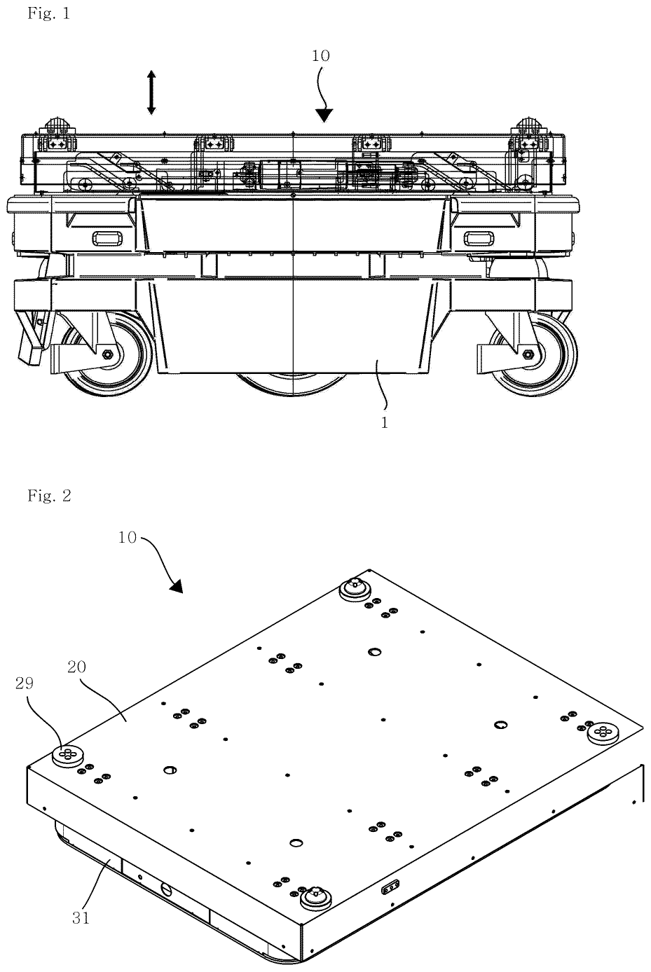

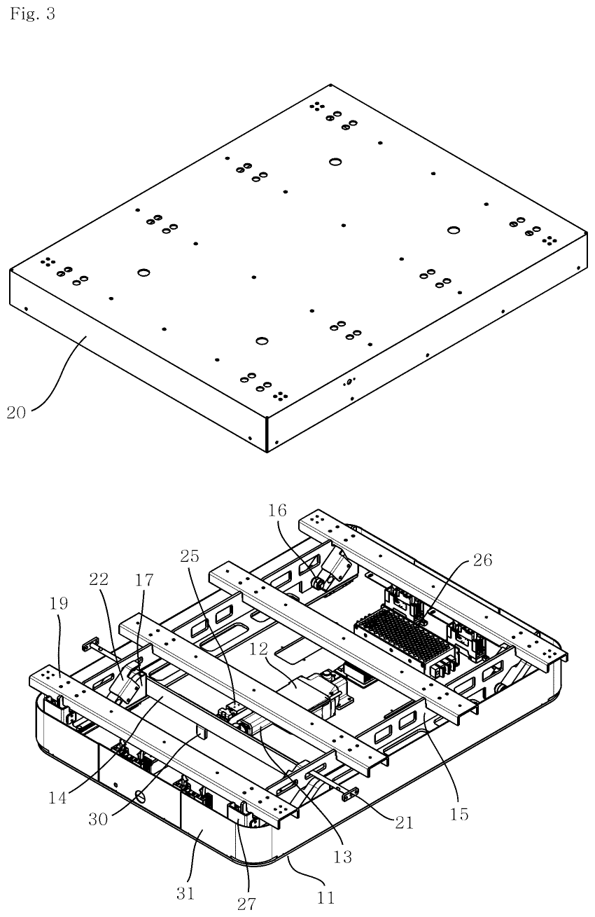

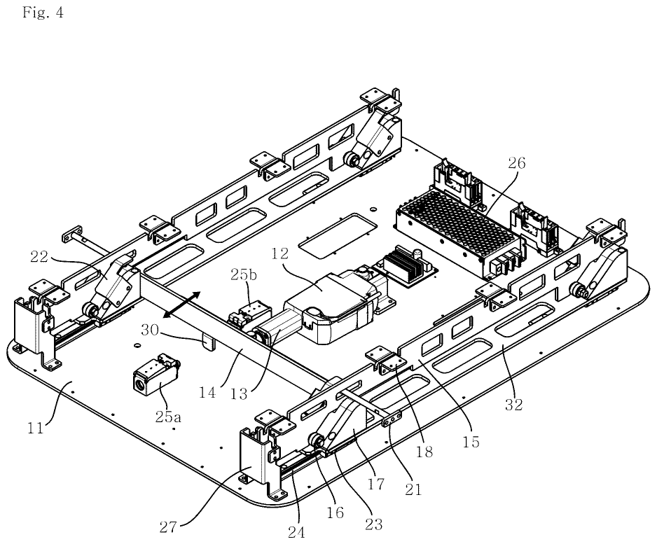

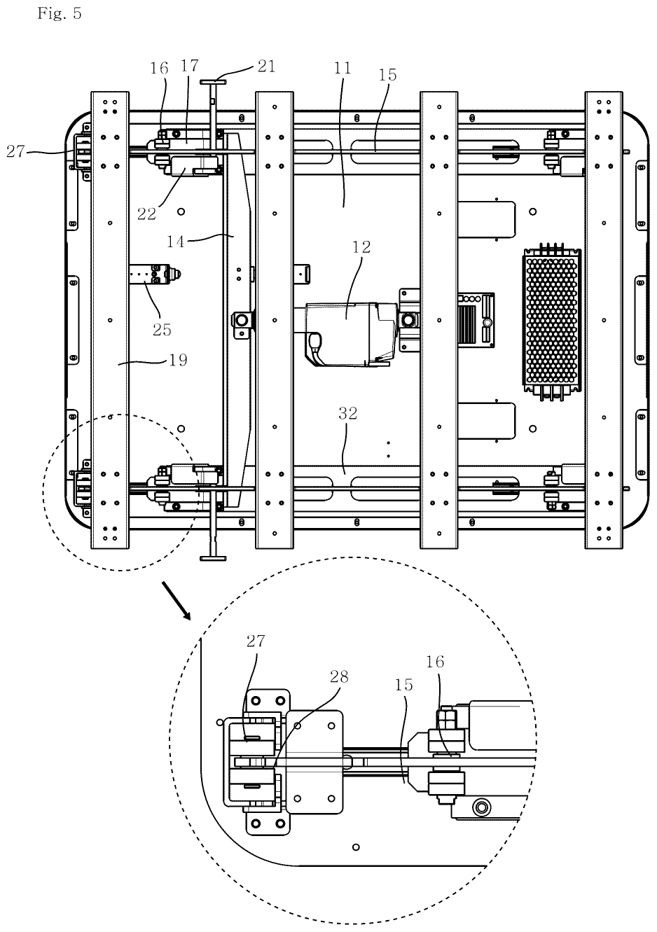

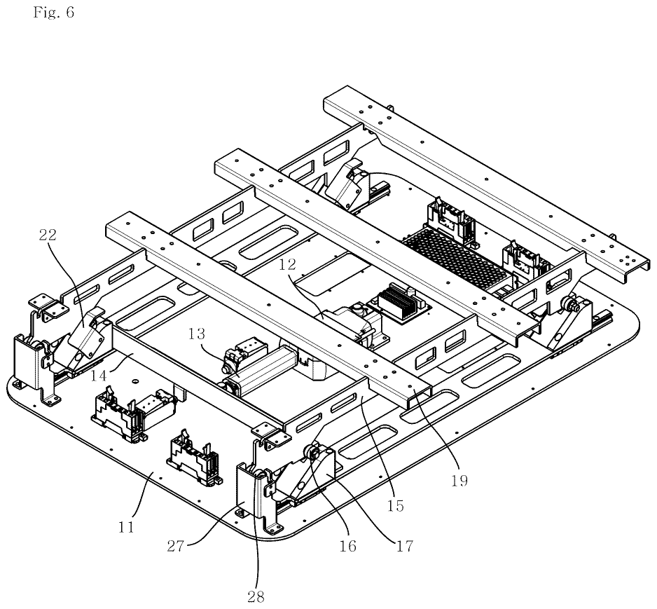

FIG. 1 is a schematic view showing an autonomous mobile robot in which a lifting device according to the present disclosure is built, FIG. 2 is a perspective view showing the lifting device according to the present disclosure, FIG. 3 is an exploded perspective view showing the lifting device according to the present disclosure, FIG. 4 is a perspective view showing a portion of the lifting device according to the present disclosure, and FIG. 5 is a plan view showing the lifting device according to the present disclosure. A lifting device 10 for an autonomous mobile robot 1 according to the present disclosure includes a base plate 11 fixedly disposed onto a top of the autonomous mobile robot 1, an actuator 12 fixedly disposed onto the base plate 11 in such a way as to operate with the power applied thereto, a driving bar 14 fixedly coupled to an actuator rod 13 that reciprocates by means of the actuator 12 and thus moves together with the actuator rod 13, slant brackets 17 fixedly coupled to the driving bar 14 and each having a slant surface with a given angle, lifting and lowering plates 15 disposed on one side of the slant brackets 17 in such a way as to be lifted and lowered by means of the movements of the slant brackets 17, and a lifting plate 20 fixedly coupled to the lifting and lowering plates 15. In this case, the lifting and lowering plates 15 are located on both sides of the base plate 11, and driven rollers 16 are located on one side of the lifting and lowering plates 15, so that if the actuator rod 13 moves to a direction of escaping from the actuator 12, the driven rollers 16 move up along the slant surfaces of the slant brackets 17 to allow the lifting and lowering plates 15 to be lifted, and then, as the lifting and lowering plates 15 are lifted, the lifting plate 20 is lifted.

First, the autonomous mobile robot 1 to which the lifting device according to the present disclosure is applied is the AMR as shown, and otherwise, it may be an AGV robot according to usage environments.

The base plate 11 is a plate that is fixedly disposed onto the top of the autonomous mobile robot 1, and the actuator 12 is fixedly disposed onto the base plate 11 in such a way as to operate with the power applied from a power supply 26. The driving bar 14 is fixedly coupled to the actuator rod 13 that operates by means of the actuator 12 and thus moves together with the actuator rod 13, and the slant brackets 17 are fixedly coupled to both sides of the driving bar 14 in such a way as to move together by means of the driving bar 14. The lifting and lowering plates 15 are disposed on both sides of the base plate 11 in such a way as to be lifted and lowered by means of the movements of the slant brackets 17, and the lifting plate 20 is fixedly coupled to the lifting and lowering plates 15 in such a way as to be lifted and lowered together with the lifting and lowering plates 15.

In this case, the lifting and lowering plates 15 are located on both sides of the base plate 11, so that they can be stably lifted and lowered, and the driven rollers 16 are located on one side of the lifting and lowering plates 15, so that if the slant brackets 17 move, the driven rollers 16 rotate along the slant surfaces of the slant brackets 17 to allow the lifting and lowering plates 15 to be lifted and lowered, and thus, the lifting plate 20 coming into close contact with the loaded items or cart is lifted and lowered.

Referring to a power transfer process of such components, first, if the actuator rod 13 extends to a direction of escaping from the actuator 12 by means of the application of power to the actuator 12, the driving bar 14 fixedly coupled to the actuator rod 13 moves to a direction distant from the actuator 12, and the slant brackets 17 fixedly coupled to both sides of the driving bar 14 move together with the movement of the driving bar 14. Next, the driven rollers 16 move up along the slant surfaces of the slant brackets 17 by means of the movements of the slant brackets 17, and then, the lifting and lowering plates 15 are lifted by means of the upward movements of the driven rollers 16. After that, reinforcing bars 19 and the lifting plate 20, which are fixedly coupled to the lifting and lowering plates 15, are lifted by means of the lifting operations of the lifting and lowering plates 15, and then, the casters of the cart, which are placed on top of the lifting plate 20, are separated from the surface of ground to thus allow the items loaded in the cart to be lifted in position.

Contrarily, if the actuator rod 13 moves to a direction of being inserting into the actuator 12 by means of the application of power to the actuator 12, the driving bar 14 fixedly coupled to the actuator rod 13 moves toward the actuator 12, and the slant brackets 17 fixedly coupled to both sides of the driving bar 14 move together with the movement of the driving bar 14. Next, the driven rollers 16 move down along the slant surfaces of the slant brackets 17 by means of the movements of the slant brackets 17, and then, the lifting and lowering plates 15 are lowered by means of the downward movements of the driven rollers 16. After that, the reinforcing bars 19 and the lifting plate 20, which are fixedly coupled to the lifting and lowering plates 15, are lowered by means of the lowering operations of the lifting and lowering plates 15.

Further, two limit switches 25 are mounted on the base plate 11, the driving bar 14 moving by means of the actuator 12 is located between the two limit switches 25, and a touch bracket 30 is fixedly located on the underside of the driving bar 14, so that the limit switches 25 sense the position of the driving bar 14 and limit the movable range of the driving bar 14.

The limit switches 25 are switches for receiving signals by means of the movements of the driving bar 14, and if the driving bar 14 moves to the left in FIG. 4, the touch bracket 30 fixed to the underside of the driving bar 14 touches the limit switch 25a located on the left of the drawing to prevent the driving bar 14 from moving anymore to the left. Contrarily, if the driving bar 14 moves to the right, the touch bracket 30 touches the limit switch 25b located on the right of the drawing to prevent the driving bar 14 from moving anymore to the right. Therefore, the limit switches 25 sense the positions of the driving bar 14 and limit the movable range of the driving bar 14, thereby restricting the maximum lifting and lowering heights of the lifting and lowering plates 15.

Further, linear motion (LM) rails 24 are located on the base plate 11, and LM blocks 23 are fixedly disposed on the slant brackets 17, so that the slant brackets 17 are guided on paths by means of the LM blocks 23 and the LM rails 24 and move smoothly.

In detail, the LM blocks 23 are disposed on the undersides of the slant brackets 17, and the LM rails 24 are located on the base plate 11 to guide the moving paths of the LM blocks 23, so that the slant brackets 17 are guided on the moving paths by means of LM guides consisting of the LM blocks 23 and the LM rails 24. In this case, the slant brackets 17 move smoothly by means of the LM guides to allow the lifting and lowering operations of the lifting and lowering plates 15 and the lifting plate 20 to be performed smoothly.

Further, the reinforcing bars 19 are fixedly coupled to the lifting and lowering plates 15 by means of reinforcing bar-fixing brackets 18, and simultaneously, they are fixedly coupled to the lifting plate 20 to enhance the durability of the lifting plate 20. In this case, the reinforcing bar-fixing brackets 18 are fixedly coupled to the lifting and lowering plates 15, so that the lifting plate 20, the reinforcing bars 19, the lifting and lowering plates 15, and the reinforcing bar-fixing brackets 18 are lifted and lowered unitarily.

In detail, the reinforcing bars 19 are fixedly coupled to the lifting and lowering plates 15 by means of the reinforcing bar-fixing brackets 18, and simultaneously, they are fixedly coupled to the lifting plate 20 to reinforce the strength of the lifting plate 20, so that even if a heavy load item or cart is placed on the lifting plate 20, the deformation in the shape of the lifting plate 20 is minimized. Under such a configuration, the lifting plate 20, the reinforcing bars 19, the lifting and lowering plates 15, and the reinforcing bar-fixing brackets 18 are lifted and lowered unitarily.

Moreover, guide brackets 22 are fixedly disposed on one side of the slant brackets 17 in such a way as to limit upward movement amounts of the driven rollers 16 when the driven rollers 16 move up along the slant surfaces of the slant brackets 17.

In detail, if the slant surfaces of the slant brackets 17 have an angle of 45° with respect to the top surface of the base plate 11, the guide brackets 22 are located on tops of the slant brackets 17 in such a way as to have the same inclination angle, that is, an angle of 45° with respect to the top surface of the base plate 11, and when the driven rollers 16 move up or down by means of the movements of the slant brackets 17, the guide brackets 22 prevent the driven rollers 16 from being separated from the slant surfaces of the slant brackets 17, so that the lifting and lowering plates 15 and the lifting plate 20 are prevented from being lifted and lowered in a state of being slanted to any one side, thereby performing their lifting and lowering operations stably.

Further, the lifting plate 20 has fixing pins 21 fixedly coupled thereto, and the fixing pins 21 coupledly pass through the lifting and lowering plates 15. One side of each fixing pin 21 is located under the corresponding guide bracket 22, thereby preventing the lifting plate 20, the reinforcing bars 19, the lifting and lowering plates 15, and the reinforcing bar-fixing brackets 18 from being separated from guide blocks 27 mounted on the base plate 11.

In detail, the fixing pins 21, which are fixedly coupled to the lifting plate 20, have the shapes of cantilevers, and one end of each fixing pin 21 is located under the corresponding guide bracket 22, so that even if the lifting plate 20 is lifted, it is prevented from being separated from the base plate 11.

In more detail, the lifting plate 20, the reinforcing bars 19, the reinforcing bar-fixing brackets 18, and the lifting and lowering plates 15 are fixed to one another and unitarily lifted and lowered, but if the lifting plate 20 is lifted up to a direction distant from the base plate 11 by means of the application of an external force, the lifting plate 20, the reinforcing bars 19, the reinforcing bar-fixing brackets 18, and the lifting and lowering plates 15 may be arbitrarily separated from one another. To avoid such a problem, the fixing pins 21 are fixed to the lifting plate 20 so that as they are locked onto the guide brackets 22, even if the lifting plate 20 is lifted up to a direction distant from the base plate 11 by means of the application of an external force, such arbitrary separation is prevented.

In this case, if the lifting plate 20 is lifted up after the fixing pins 21 have been separated from the lifting plate 20, the lifting plate 20, the reinforcing bars 19, the reinforcing bar-fixing brackets 18, and the lifting and lowering plates 15 are separated from the guide blocks 27 at a time, so that if there is a need to perform maintenance for various components mounted on the base plate 11, such as the actuator 12 or the power supply 26, and the like, the fixing pins 21 are separated from the lifting plate 20 to allow the lifting plate 20, the reinforcing bars 19, the reinforcing bar-fixing brackets 18, and the lifting and lowering plates 15 to be separated from the guide blocks 27, and next, the maintenance for the components is conveniently performed.

Further, the guide blocks 27 are mounted on the base plate 11, and lifting and lowering guide rollers 28 are located on one side of the lifting and lowering plates 15, so that while the lifting and lowering plates 15 are being lifted and lowered, the lifting and lowering guide rollers 28 move, while being guided on moving paths by means of the guide blocks 27, and are smoothly lifted and lowered.

In detail, the guide blocks 27, which are mounted on the base plate 11, serve to guide lifting and lowering paths when the lifting and lowering plates 15 are lifted and lowered, and further, the lifting and lowering guide rollers 28 are located on one side of the lifting and lowering plates 15, so that in a state where the lifting and lowering guide rollers 28 are brought into close contact with the guide blocks 27, the lifting and lowering plates 15 are lifted and lowered, thereby allowing the lifting plate 20, the reinforcing bars 19, the reinforcing bar-fixing brackets 18, and the lifting and lowering plates 15 to be smoothly lifted and lowered.

FIG. 6 is an exemplary view showing an operation of the lifting device according to the present disclosure. In this case, the driving bar 14 moves to the left of the drawing by means of the operation of the actuator 12 to allow the lifting and lowering plates 15, the driven rollers 16, and the reinforcing bars 19 to be lifted.

Reference numerals not explained yet are 29 representing locating pins, 31 representing a cover, and 32 representing connection frames. The locating pins 29 are fixed to the lifting plate 20 to accurately guide the cart or items to be loaded to a predetermined position on the lifting plate 20, the cover 31 is fixedly mounted onto the base plate 11 to protect the internal components such as the actuator 12 and the like from the outside, and the connection frames 32 serve to fix the front side slant brackets 17 to the rear side slant brackets 17 to allow the front side slant brackets 17 and the rear side slant brackets 17 to move together.

As described above, the lifting device for the autonomous mobile robot according to the present disclosure can be used to lift the cart in which items are received to a given height to allow the autonomous mobile robot to deliver the items to a given place, thereby preventing wheels (casters) mounted on the cart from being worn out and transferring the items, without any additional labor.

Further, the lifting device for the autonomous mobile robot according to the present disclosure can have the two limit switches mounted on the base plate, the driving bar located between the two limit switches in such a way as to move by means of the actuator, and the touch bracket fixedly located on the underside of the driving bar, so that the limit switches serve to sense the position of the driving bar and limit the movable range of the driving bar, thereby preventing malfunctions from occurring.

Furthermore, the lifting device for the autonomous mobile robot according to the present disclosure can have the LM rails located on the base plate and the LM blocks fixedly disposed on the slant brackets, so that the slant brackets are guided on paths by means of the LM blocks and the LM rails and move smoothly.

Moreover, the lifting device for the autonomous mobile robot according to the present disclosure can have the fixing pins fixedly coupled to the lifting plate in such a way as to coupledly pass through the lifting and lowering plates, so that as one side of each fixing pin is located under the corresponding guide bracket, the lifting plate, the reinforcing bars, the lifting and lowering plates, and the reinforcing bar-fixing brackets are prevented from being separated from the outsides of the guide blocks, thereby reducing the occurrence of safety accidents, and if necessary, the fixing pins are separated from the lifting plate, the lifting plate, the reinforcing bars, the reinforcing bar-fixing brackets, and the lifting and lowering plates are separated from the guide blocks at a time, thereby performing the maintenance for the components conveniently.

In addition, the lifting device for the autonomous mobile robot according to the present disclosure can have the guide blocks mounted on the base plate and the lifting and lowering guide rollers located on one side of the lifting and lowering plates, so that while the lifting and lowering plates are being lifted and lowered, the lifting and lowering guide rollers move, while being guided on moving paths by means of the guide blocks, and are smoothly lifted and lowered.

While the present disclosure has been given with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. A lifting device for an autonomous mobile robot, comprising:
a base plate (11) fixedly disposed onto a top of the autonomous mobile robot (1);
an actuator (12) fixedly disposed onto the base plate (11) in such a way as to operate with the power applied thereto;
a driving bar (14) fixedly coupled to an actuator rod (13) that reciprocates by means of the actuator (12) and thus moves together with the actuator rod (13);
slant brackets (17) fixedly coupled to the driving bar (14) and each having a slant surface with a given angle;
lifting and lowering plates (15) disposed on one side of the slant brackets (17) in such a way as to be lifted and lowered by means of the movements of the slant brackets (17); and
a lifting plate (20) fixedly coupled to the lifting and lowering plates (15),
wherein the lifting and lowering plates (15) are located on both sides of the base plate (11) and have driven rollers (16) located on one side thereof, so that if the actuator rod (13) moves to a direction of escaping from the actuator (12), the driven rollers (16) move up along the slant surfaces of the slant brackets (17) to allow the lifting and lowering plates (15) to be lifted, and then, as the lifting and lowering plates (15) are lifted, the lifting plate (20) is lifted,
the lifting and lowering plates (15) have reinforcing bars (19) fixedly coupled thereto by means of reinforcing bar-fixing brackets (18) in such a way as to be fixedly coupled to the lifting plate (20) to enhance the durability of the lifting plate (20), the reinforcing bar-fixing brackets (18) being fixedly coupled to the lifting and lowering plates (15), so that the lifting plate (20), the reinforcing bars (19), the lifting and lowering plates (15), and the reinforcing bar-fixing brackets (18) are lifted and lowered unitarily, and
the lifting plate (20) has fixing pins (21) fixedly coupled thereto in such a way as to coupledly pass through the lifting and lowering plates (15), one side of each fixing pin (21) being located under a guide bracket (22) fixedly disposed on one side of the corresponding slant bracket (17), so that the lifting plate (20), the reinforcing bars (19), the lifting and lowering plates (15), and the reinforcing bar-fixing brackets (18) are prevented from being separated from guide blocks (27) mounted on the base plate (11).

2. The lifting device according to claim 1, wherein the base plate (11) has two limit switches (25) mounted thereon, the driving bar (14) located between the two limit switches (25) in such a way as to move by means of the actuator (12), and a touch bracket (30) fixedly located on the underside of the driving bar (14), so that the limit switches (25) sense the position of the driving bar (14) and thus limit the movable range of the driving bar (14).

3. The lifting device according to claim 1, wherein the base plate (11) has linear motion (LM) rails (24) located thereon, and the slant brackets (17) have LM blocks (23) fixedly disposed thereon, so that the slant brackets (17) are guided on paths by means of the LM blocks (23) and the LM rails (24) and move smoothly.

4. The lifting device according to claim 1, wherein the guide brackets (22) are fixedly disposed on one side of the slant brackets (17) in such a way as to limit upward movement amounts of the driven rollers (16) when the driven rollers (16) move up along the slant surfaces of the slant brackets (17).

5. The lifting device according to claim 1, wherein the base plate (11) have the guide blocks (27) mounted thereon, and the lifting and lowering plates (15) have lifting and lowering guide rollers (28) located on one side thereof, so that while the lifting and lowering plates (15) are being lifted and lowered, the lifting and lowering guide rollers (28) move, while being guided on moving paths by means of the guide blocks (27), and are smoothly lifted and lowered.
